(19) United States
(12) Patent Application Publication
(10) Pub. No.: US 2018/0096436 A1
(43) Pub. Date: Apr. 5, 2018

(54) Computing System for Automatically Obtaining Age Data in a Social Data Network

(71) Applicant: Sysomos L.P., Toronto (CA)

(72) Inventors: Koushik PAL, Etobicoke (CA); Edward Dong-Jin KIM, Toronto (CA); Kanchana PADMANABHAN, Toronto (CA)

(73) Assignee: Sysomos L.P., Toronto (CA)

(21) Appl. No.: 15/447,878

(22) Filed: Mar. 2, 2017

Related U.S. Application Data
(60) Provisional application No. 62/403,371, filed on Oct. 3, 2016.

(51) Int. Cl. G06Q 50/00; G06F 17/30

(52) U.S. Cl. CPC G06Q 50/01; G06F 17/30371

(57) ABSTRACT

In social data networks, it is difficult for a computing system to automatically identify age attributes associated with user accounts because of incorrect, incomplete or non-existent data associated with the user account profile. Therefore, a computing system is provided that retrieves user account data and related text data, and that uses classification to identify age data. Label propagation computations based on the connections in the social data network are used to infer the age information of many user accounts at the same time.

### CROSS-REFERENCE TO RELATED APPLICATIONS

This application claims priority to U.S. Provisional Patent Application No. 62/403,371 filed on Oct. 3, 2016, and titled “Computing System for Automatically Obtaining Age Data in a Social Data Network” and the entire contents of which is incorporated herein by reference.

### TECHNICAL FIELD

The following generally relates to a computing system for automatically obtaining age data in a social data network.

### DESCRIPTION OF THE RELATED ART

The amount of data being created by people using electronic devices, or simply data obtained from electronic devices, has been growing over the last several years. Digital data is created and transmitted over various social media. This data often includes attributes about a person, or people. These attributes may include their age. Age data, for example, is obtained or identified using metadata, tags, user-profile forms, etc. These attributes are used, for example, by digital organizations to provide targeted advertising, targeted product and service offerings, targeted digital content (e.g. news articles, videos, posts, etc.), or combinations thereof. In some cases, attributes, including age, about a person are used for verification or digital security purposes.

However, attributes about a person or people are often incomplete, or incorrect, or even non-existent. For example, a person may purposely withhold their age information or may provide false information about themselves. This incomplete, incorrect or altogether missing digital data therefore disrupts the effectiveness of down-stream software applications and computing systems that use the attribute data.

### BRIEF DESCRIPTION OF THE DRAWINGS

Embodiments will now be described by way of example only with reference to the appended drawings wherein:

FIG. 1 is an example of a social network graph comprising nodes and edges.

FIG. 2 is a system diagram including a server system in communication with other computing devices.

FIG. 3 is a schematic diagram showing another example embodiment of the server system of FIG. 2, but in isolation.

FIG. 4 is an example embodiment of a server system architecture, also showing the flow of information amongst databases and modules.

FIG. 5 is a flow diagram showing example executable instructions for obtaining age data in a social data network.

FIG. 6 is a flow diagram showing example executable instructions for computing an initial list of user accounts having known ages.

FIG. 7 is a flow diagram showing example executable instructions for computing an intermediary list of seed users.

FIG. 8 is a flow diagram showing example executable instructions for computing an inferred age of a user in the social data network, based on the seed users.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

In online data systems, such as social data networks, correctly identifying attributes of a person or people are important. For example, correct identification of a person is used for data security, targeted digital advertising, and customized data content, among other things. Segmentation consists of dividing an audience into groups of people with common needs or preferences who are likely to react to an ad in the same way. The rapid growth of social media has sparked in recent years increasing interests in the research and development of techniques for segmenting online users based on their demographic features.

It is also recognized that in typical social media networks or platforms, only a small percentage (e.g. 2-5%) of user accounts have demographic information accurately disclosed on their user account profiles. Trying to compute the demographic information for users that is highly accurate, is a difficult computing problem given such limited data. In particular, inferring the correct age associated with a user account is difficult.

For a computing system to determine a gender for a user account, the technical difficulty is increased when there is little self-published information about the user. For example, a user may not publish text or digital photos about themselves, thereby providing little data for a computing system to compute an age determination.

Furthermore, even if the data is provided, it is herein recognized that the age information may be false. For example, users in social data networks may create false accounts. Or, photos or age information about a user is outdated. Accurately determining the age based on the self-published information, therefore, may not be reliable.

The proposed computing systems and methods use high performance classifiers for identifying the age of social media users. In particular, the computing system is configured to find, for example, the most probable age of as many users of a social data network as possible. This computation approach includes using the connections identified in a social data network.

For example, in a social data network, such as Twitter, a given user may follow a celebrity, such as Justin Bieber, who has 80 million followers. Of these followers, for example, 70% are teenagers. Therefore, if the given user follows Justin Bieber, there is a high chance that the given user himself/herself is a teenager. However, it is herein recognized that accurately determining the ratio of the different age groups that follow Justin Bieber, or another popular user account, is difficult. The computing system described herein and the related computations address one or more of the above technical difficulties.

Social data networks, also called social networking platforms, include users who generate and post content for others to see, hear, etc (e.g. via a network of computing devices communicating through websites associated with the social networking platform). Non-limiting examples of social networking platforms are Facebook, Twitter, LinkedIn, Pinterest, Tumblr, Snapchat, blogospheres, websites, collaborative wikis, online newsgroups, online forums, emails, and instant messaging services. Currently known and future known social networking platforms may be used with principles described herein.

The term “post” or “posting” refers to content that is shared with others via social data networking. A post or posting may be transmitted by submitting content on to a server or website or network for other to access. A post or posting may also be transmitted as a message between two devices. A post or posting includes sending a message, an email, placing a comment on a website, placing content on a blog, posting content on a video sharing network, and placing content on a networking application. Forms of posts include text, images, video, audio and combinations thereof. In the example of Twitter, a tweet is considered a post or posting.

The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user (i.e. the followee). In some cases, a follower engages with the content posted by the other user (e.g. by sharing or reposting the content). A followee may also be called a friend.

In the proposed system and method, edges or connections, are used to develop a network graph and several different types of edges or connections are considered between different user nodes (e.g. user accounts) in a social data network. These types of edges or connections include: (a) a follower relationship in which a user follows another user; (b) a repost relationship in which a user re-sends or re-posts the same content from another user; (c) a reply relationship in which a user replies to content posted or sent by another user; and (d) a mention relationship in which a user mentions another user in a posting.

In a non-limiting example of a social network under the trade name Twitter, the relationships are as follows:

Re-tweet (RT): Occurs when one user shares the tweet of another user. Denoted by “RT” followed by a space, followed by the symbol @, and followed by the Twitter user handle, e.g., “RT @ABC followed by a tweet from ABC).

@Reply: Occurs when a user explicitly replies to a tweet by another user. Denoted by ‘@’ sign followed by the Twitter user handle, e.g., @username and then follow with any message.

@Mention: Occurs when one user includes another user's handle in a tweet without meaning to explicitly reply. A user includes an @ followed by some Twitter user handle somewhere in his/her tweet, e.g., Hi @XYZ let's party @DEF @TUV

These relationships denote an explicit interest from the source user handle towards the target user handle. The source is the user handle who re-tweets or @replies or @mentions and the target is the user handle included in the message. It will be appreciated that the nomenclature for identifying the relationships may change with respect to different social network platforms. While examples are provided herein with respect to Twitter, the principles also apply to other social network platforms.

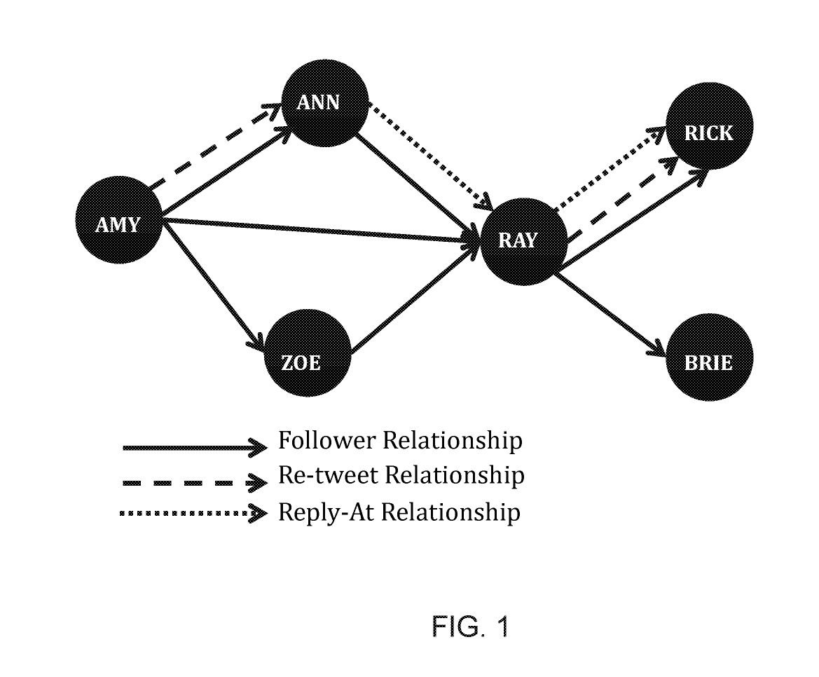

To illustrate the proposed approach, consider the network graph in FIG. 1, which depicts the user accounts of Ann, Amy, Ray, Zoe, Rick and Brie as nodes. Their relationships are represented as directed edges between the nodes. The computing system analyzes the text content (e.g. re-tweets, posts, replies, tweets, shares, etc.) between the users to determine “textual similarity”.

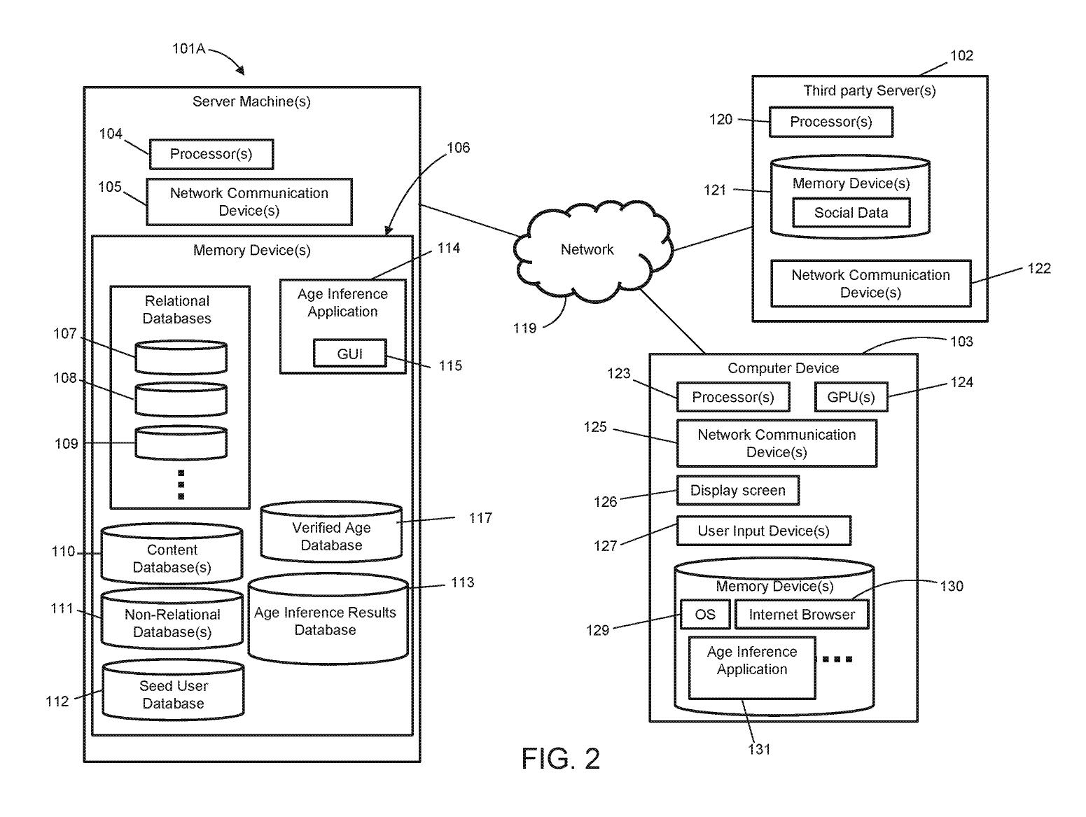

Turning to FIG. 2 an example embodiment of a server system 101A is provided for inferring a gender attribute of a user. The server system 101A may also be called a computing system.

The server system 101A includes one or more processors 104. In an example embodiment, the server system includes multi-core processors. In an example embodiment, the processors include one or more main processors and one or more graphic processing units (GPUs). While GPUs are typically used to process images (e.g. computer graphics), in this example embodiment they are used herein to process social data. For example, the social data is graph data (e.g. nodes and edges).

The server system also includes one or more network communication devices 105 (e.g. network cards) for communicating over a data network 119 (e.g. the Internet, a closed network, or both).

The server system further includes one or more memory devices 106 that store one or more relational databases 107, 108, 109 that map the activity and relationships between user accounts. The memory further includes a content database 110 that stores data generated by, posted by, consumed by, re-posted by, etc. users. The content includes text, images, audio data, video data, or combinations thereof. The memory further includes a non-relational database 111 that stores friends and followers associated with given users. The memory further includes a seed user database 112 that stores seed user accounts having known age information, and an age inference results database 113. Also stored in memory is a verified age database 117, which stores an initial set of user accounts having verified age data.

The memory 106 also includes an age inference application 114.

For clarity, user accounts and users may be herein used interchangeably. Furthermore, the various relationships in a social data network may herein be generalized as a “follower” or “follower relationship”.

The server system 101A may be in communication with one or more third party servers 102 over the network 119. Each third party server having a processor 120, a memory device 121 and a network communication device 122. For example, the third party servers are the social network platforms (e.g. Twitter, Instagram, Facebook, Snapchat, etc.) and have stored thereon the social data (e.g. text data, posts, messages, videos, images, etc.), which is sent to the server system 101A.

In an example embodiment, at least one of the third party servers 102 hosts a reputable information website that contains information about people (e.g. Wikipedia website, a newspaper website, IMDB website, etc.).

The server system 101A may also be in communication with one or more user computing devices 103 (e.g. mobile devices, wearable computers, desktop computers, laptops, tablets, etc.) over the network 119. The computing device, for example, includes one or more processors 123, one or more GPUs 124, a network communication device 125, a display screen 126, one or more user input devices 127, and one or more memory devices 128. The computing device has stored thereon, for example, an operating system (OS) 129, an Internet browser 130 and an age inference application 131. In an example embodiment, the age inference application 114 on the server is accessed by the computing device 103 via the Internet Browser 130. In another example embodiment, the age inference application 114 is accessed by the computing device 103 via its local age inference application 131. While the GPU 124 is typically used by the computing device for processing graphics, the GPU 124 may also be used to perform computations related to the social media data.

It will be appreciated that the server system 101A may be a collection of server machines or may be a single server machine.

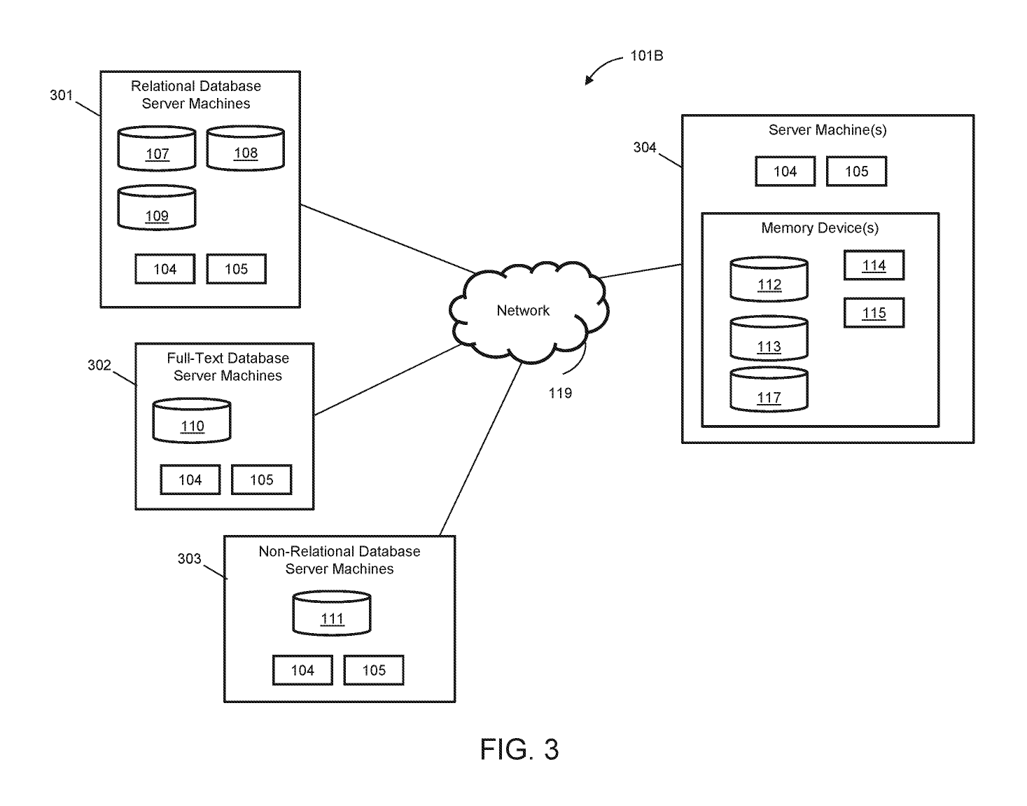

Turning to FIG. 3, an alternative example embodiment to the server system 101A is shown as multiple server machines in the server system 101B. The server system 101B includes one or more relational database server machines 301, that store the databases 107, 108 and 109. The system 101B also includes one or more full-text database server machines 302 that stores the database 110. The system 101B also includes one or more non-relational database server machines 303 that store the database 111. The system 101B also includes one or more server machines 304 that store the databases 112, 113, 117 and the applications or modules 114 and 115.

It will be appreciated that the distribution of the databases, the applications and the modules may vary other than what is shown in FIGS. 2 and 3.

For simplicity, the example embodiment server systems 101A or 101B, or both, will hereon be referred to using the reference numeral 101.

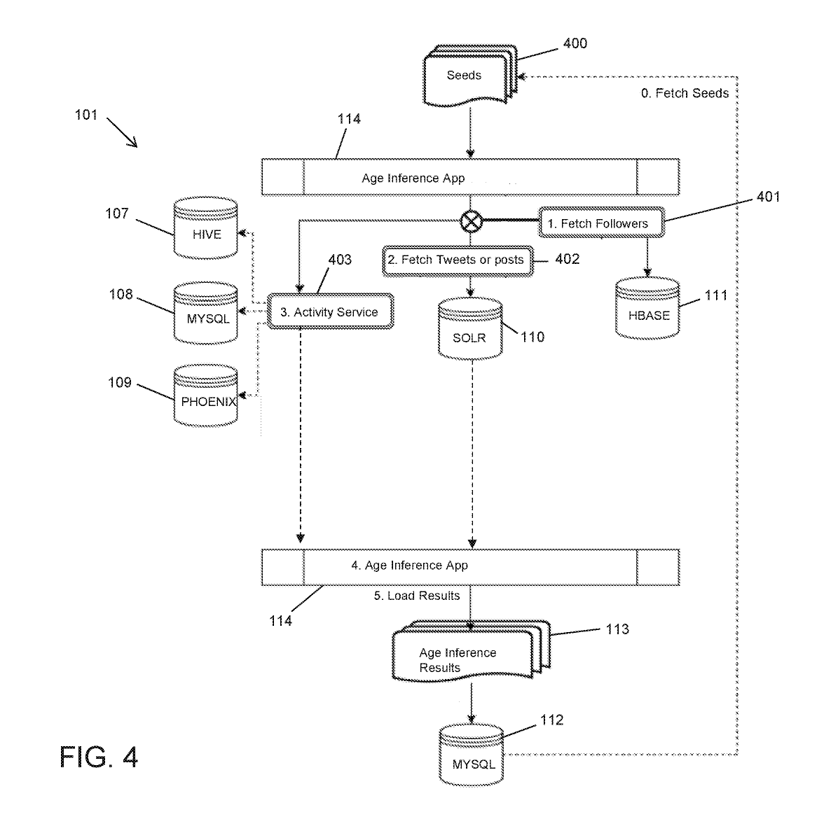

FIG. 4 shows an example architecture of the server system 101 and the flow of data amongst databases and modules.

As an initial step, the server system 101 obtains one or more seed user accounts (also called seeds or seed users) 400 from the database 112. In an example embodiment, the seed users accounts are those accounts in a social networking platform having known demographic attributes. The database 112, for example, is a MYSQL type database.

The one or more seeds 400 are passed by the server system 101 into its demographic inference application 114.

Responsive to receiving the seeds 400, the age inference application 114 obtains followers (block 401) of one or more given seeds. The followers, for example, are obtained by accessing the database 111, which for example is an HBASE database.

In this example implementation, an HBASE distributed Titan Graph database 111 runs on top of a Hadoop Distributed File System (HDFS) to store the social network graph (e.g., in a server cluster configuration comprising fifteen server machines). In other words, in an example implementation, the server machines 303 comprises multiple server machines that operate as a cluster.

In the example embodiment, the computing system may access the Tweets or other posts (block 402) to determine if there is a follower relationship.

In this example implementation, the content database 110 is a SOLR type database. SOLR is an enterprise search platform that runs as a standalone full-text server 302. It uses the Lucene Java search library as its core for full-text indexing and search.

In an example embodiment, responsive to receiving the seeds 400, the application 114 may further access one or more of the relational databases 107, 108, 109 to determine the activity service of the seeds and the subject user (block 403). The activity service includes the replies, repost, posts, mentions, follows, likes, dislikes, etc. between the subject user and the one or more seed users, and may be used to determine if a follower relationship exists.

It will be appreciated that there are multiple ways for a computing system to obtain or determine via computation, whether or not there is a follower relationship between user accounts in a social data network.

In this example embodiment, the databases 107, 108, 109 are respectively a HIVE database, a MYSQL database and a PHOENIX database. HIVE is a data warehouse infrastructure built on top of Hadoop for providing data summarization, query, and analysis. MYSQL is a relational database management system. PHOENIX is a massively parallel, relational database layer on top of noSQL stores such as Apache HBase. Phoenix provides a Java Database Connectivity (JDBC) driver that hides the intricacies of the noSQL store enabling users to create, delete, and alter SQL tables, views, indexes, and sequences; upsert and delete rows singly and in bulk; and query data through SQL.

The application 114 stores the inferred age result in the database 113.

The inferred age result may be used to update the ages of the subject users in other databases, including but not limited to the followers associated with the users in the seed database 112.

The above computing systems are for example. Other computing systems and computing architectures that are configured to store and process the social network data to determine the most probable age of a large number of user accounts, are also applicable to the principles described herein.

In general, the computing system 101 obtains the follower age distributions of certain user, from a sample of followers of those certain users. In an example embodiment, a weighted sum of these age distributions are computed. The computing system uses these computed age distributions to compute an inferred age of the followers. For example, if 70% of Alice's followers are teenagers, 60% of Bob's followers are teenagers, and Cody follows both Alice and Bob, then the computing system computes that Cody is a teenager with a probability of (0.7+0.6)/2=0.65.

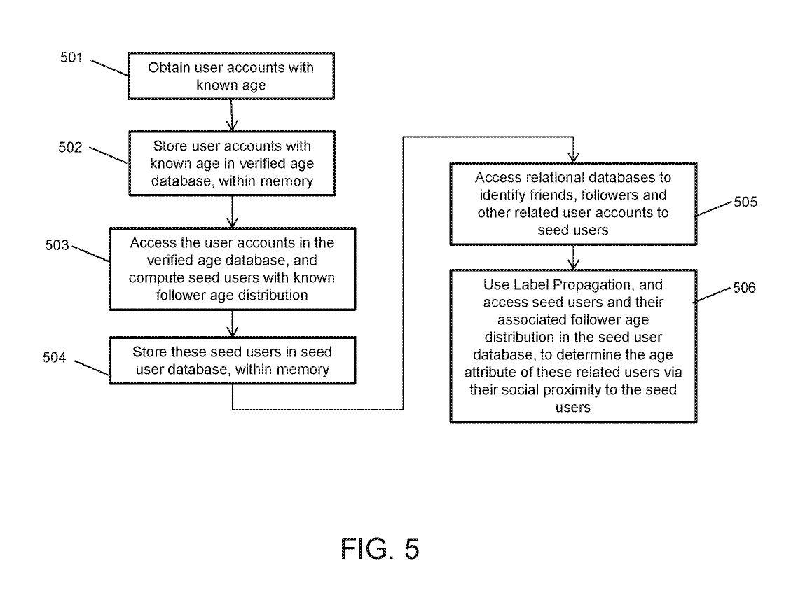

FIG. 5 shows an example of processor executable instructions for determining the age using label propagation over a social data network.

At block 501, the computing system obtains user accounts with known age information. At block 502, the computing system stores user accounts with known age information in the verified age database 117, within memory. At block 503, the computing system accesses the user accounts in the verified age database 117, in order to compute seed users with known age distributions of their followers. At block 504, the computing system stores these seed users in a seed user database 112, within memory. At block 505, the computing system accesses one or more relational databases to identify friends, followers and other related user accounts to seed users. At block 506, the computing system uses label propagation, and accesses seed users and their associated follower age distribution in the seed user database, to determine the gender attribute of these related users via their social proximity to the seed users.

The term “follower age distribution” herein refers to the user having followers spread across different age groups, and the distribution of the ages of these followers. For example, Bob has 100 followers in the social data network, with a follower age distribution as follows: in the age group 10-20 there are 30 followers; in the age group 21-30 there are 20 followers; in the age group 31-40 there are 20 followers; in the age group 41-50 there are 10 followers; in the age group 51-60 there are 10 followers; and in the age group 61-70 there are 10 followers.

In an example embodiment, the age attribute may be represented as a probability number associated a given age group, also called age bin. In another example embodiment, the age attribute is represented as an age range, or a number representing a specific age, or a word, phrase or symbol indicating an age group.

These computed age values may be used by the application 114 to determine the inferred age attribute of the given user account, which is then processed for display via the GUI 115. The graphical result in the GUI is transmitted over the network 119, for example, to a user computing device 103 for display thereon (e.g. on its display screen 126).

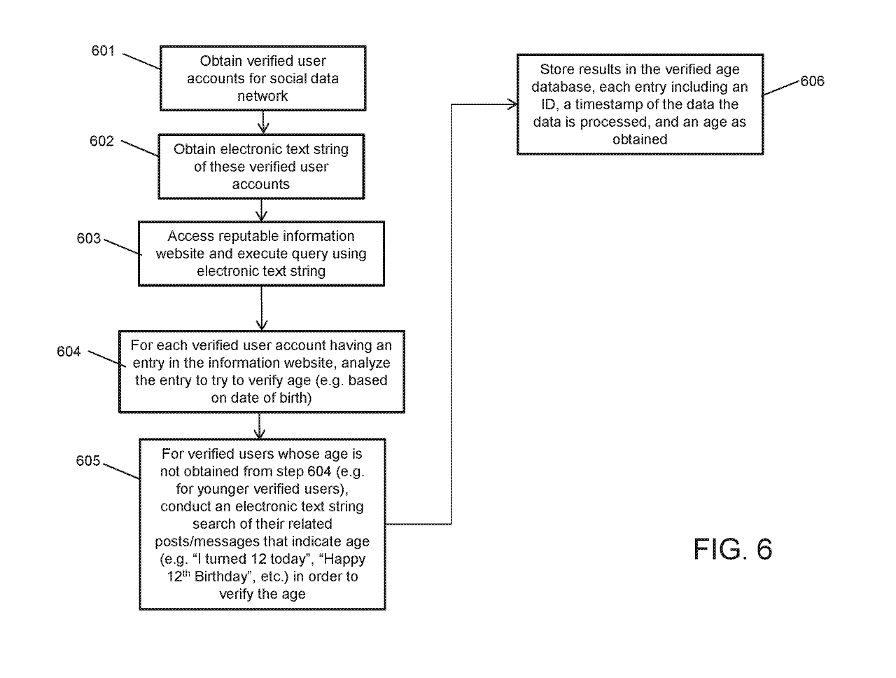

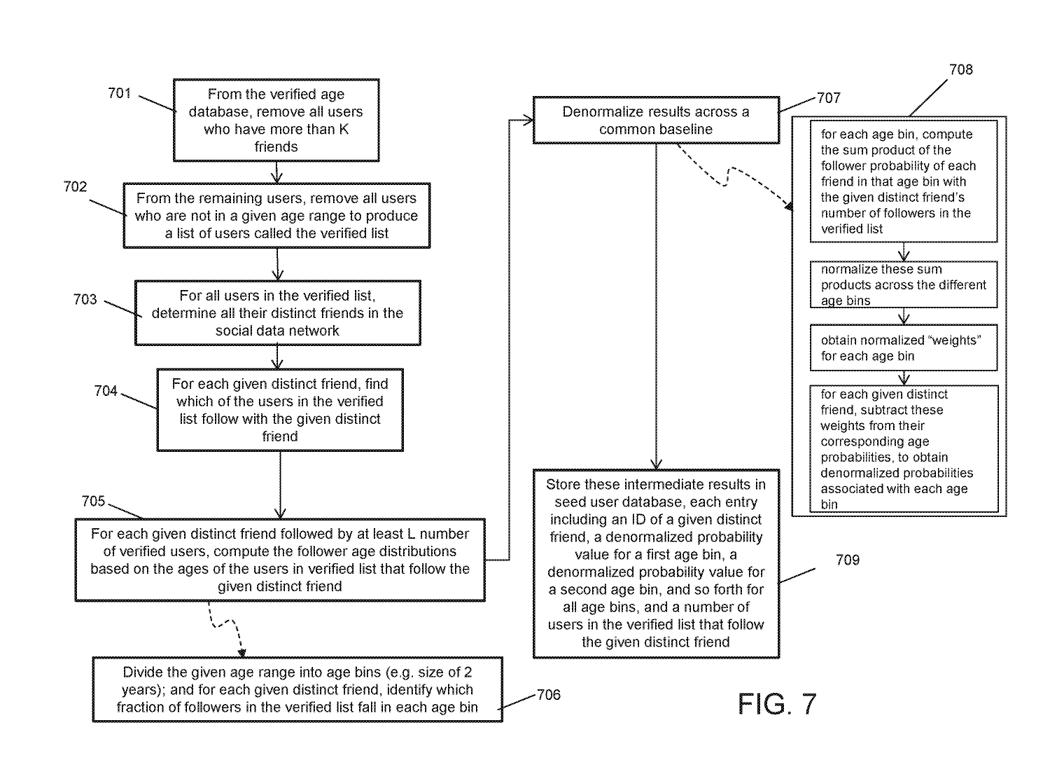

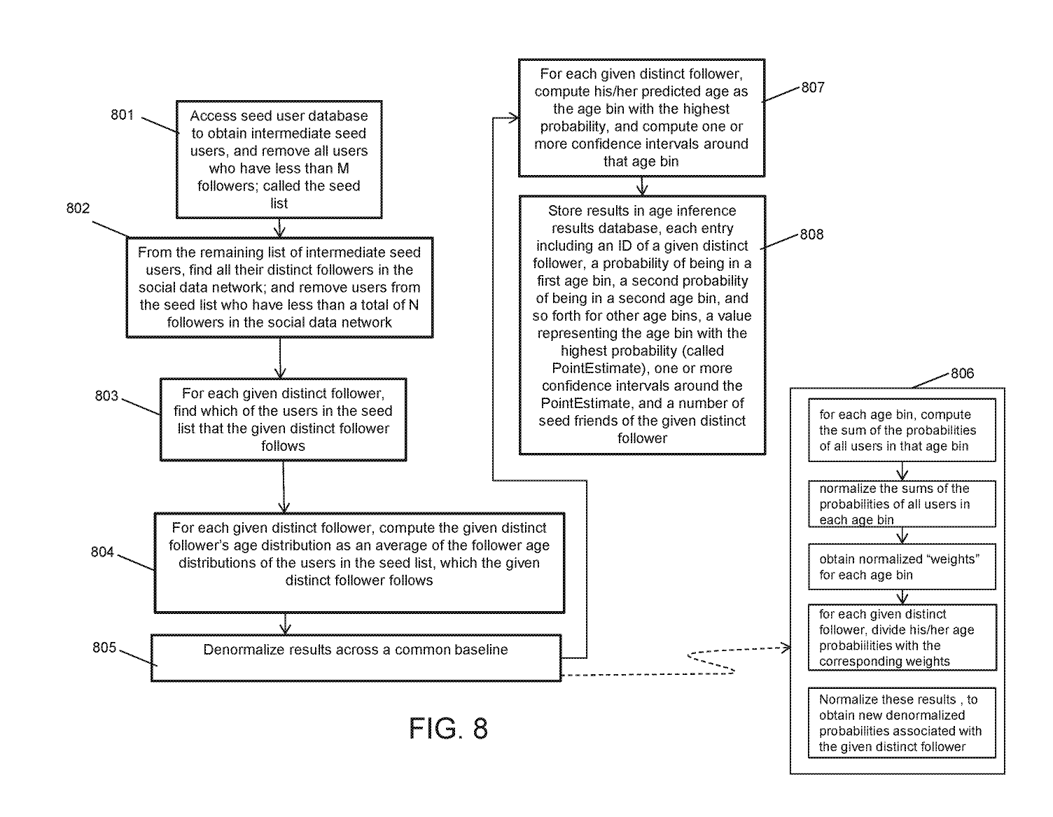

FIG. 6 provides an example of detailed executable instructions to implement blocks 501 and 502; FIG. 7 provides an example of detailed executable instructions to implements blocks 503 and 504; and FIG. 8 provides an example of detailed executable instructions to implement blocks 505 and 506.

Turning to FIG. 6, the executable instructions are used to compute a list of user accounts whose age information are known (e.g. with high confidence).

At block 601, the computing system obtains a list of verified user accounts accounts on Twitter, or some other social data network. This can be done, for example, by querying the MySQL table user_profile in a database, where the user_profile includes an indication of whether or not the user account is verified. In an example embodiment, Twitter has verified user accounts. In Twitter, a blue verified badge lets people know that a user account of public interest is authentic. In a general example embodiment, not limited to Twitter, a social data network provides verification of a user account. In another example embodiment, the computing system verifies user accounts in a social data network. For example, influential users or users considered to be experts may be used to determine verified users. For example, users accounts belonging to Justin Bieber, President Obama, and Dr. Stephen Hawking are considered as verified users.

At block 602, the computing system obtains the actual electronic text string names of these verified accounts. For example, this can be done by searching the name field associated with their user accounts.

At block 603, the computing system then accesses one or more information websites (e.g. hosted by a third party server 102) and submits the electronic text string of the name as a search term, thereby executing a query. For example, a search for the high authority users is performed on the wiki mongo database (created from the Wikipedia data dumped on DBpedia). Other non-limiting examples of information websites include www.IMDB.com and www.wikipedia.com.

At block 604, for each high authority user account having an entry in the intersection of Twitter verified accounts and the website, as returned by the query, the computing system determines their age from the website. For example, this is based on identifying the date of birth and then computing the age using the present date.

Some of the verified users may not be searchable in the one or more information websites. For example, younger users, or users who are not as popular, may not be documented on websites. Therefore, at block 605, for each of the remaining verified users whose age is not obtained in block 604, the computing system performs a text search of the data associated with the give verified user (e.g. their posts, tweets, messages, comments, etc.). The text search is focused on identifying an age in the data, along with the publication/posting date of the data. For example, on Jan. 1, 2001, a post from a user may read “I am 12 today”. Therefore, based on a current year of 2016, the computing system automatically computes that the user is age 27. The computing system may also search posts or messages from other users directed to the given verified user that indicate age, such as “Happy 12^{th} Birthday”, and identify the corresponding date that the message was sent. In an example embodiment, certain key phrases are searched in the electronic text to identify such age-revealing data.

At block 606, the computing system stores the results in the verified age database, each entry including an ID of the verified user, a timestamp of the date that the computing system processed the data, and an age of the verified user as obtained from the process. In an example embodiment, the data is stored in a table called VerifiedAge in the following json format:

```
{
    ID: TwitterID of high authority account a
    Timestamp: Date that this data is processed
    Age: Age of a as obtained above
}
```

Turning to FIG. 7, the computing system obtains a list of seed users whose follower age distributions are known (e.g. with high confidence) given a list of users whose age data are known (e.g. with high confidence). These list of users whose age data are known were determined in FIG. 6.

At block 701, from the list of users whose ages are known, the computing system removes all users who have more than K friends (e.g. followees), as they follow too many people to provide any meaningful information. For example, K=10000. However, the value of K may be different.

At block 702, from the remaining users, the computing system further removes all users that are not within a given age range. The remaining list is called the Verified list. The given age range is based on an age range of interest. In an example embodiment, the age range of interest is 12-71. However, other age ranges may be used.

At block 703, for all users in this Verified list, the computing system finds all their distinct friends on the social data network (e.g. Twitter).

In an example embodiment, the term “distinct friend” refers to a unique user account. For example, Alice and Bob are users in the Verified list. Alice has friends John and Jane, and Bob has friends Jane and Mike. In determining the distinct friends, Jane is not counted twice, and therefore the distinct friends of Alice and Bob are John. Jane and Mike.

At block 704, for each given distinct friend, the computing system determines which of the users in the Verified list follow the given distinct friend.

At block 705, for each given distinct friend who is followed by at least L number of users in the Verified list, the computing system computes the given distinct friend's follower age distributions from the age details of the users in the Verified list that follow the given distinct friend. In an example embodiment, L is 10.

In an example aspect of executing block 705, at block 706, the computing system divides the given age range into age bins to provide a smoothing effect on the computed distribution. For example, each age bin has a size of 2 years, but other sizes of age bins can be used. For example, with the age range of 12-71 and age bins of size 2, the age bins include 12-13, 14-15, 16-17, . . . , 70-71. For each given distinct friend, the computing system identifies which fraction of followers in the verified list falls within each of these age bins. This series of computations is used to output a follower age distribution.

At block 707, after the follower age distributions of all the distinct friends are computed, the computing system denormalizes the results across a common baseline so that the scores or results in the different age groups (also called age bins) are comparable. This process includes finding an average error, and then reducing the average error for each age group.

In an example aspect of implementing block 707, block 708 includes a series of computing operations for denormalization. For each age bin, the computing system computes the sum product of the probability of each friend in that age bin with the given distinct friend's number of followers in the Verified list. The computing system then normalizes these sum products across the different age bins and obtains normalized “weights” for each age bin. Then, for each distinct friend, the computing system subtracts these weights from their corresponding age probabilities, to obtain denormalized probabilities associated with each age bin. Some of these weights will be negative (e.g. below 0), and the computing system propagates these weights.

At block 709, the computing system stores these results in a seed user database as intermediate seed users, each entry including an ID of a given distinct friend, a denormalized probability value for a first age bin, a denormalized probability value for a second age bin, and so forth for all age bins, and a number of users in the verified list that follow the given distinct friend.

In an example implementation, the results are stored in a table called SeedsAge in the following json format:

```
    {
      ID: TwitterID of friend a
      12-13FollowerRatio: Denormalized score for the age group 12-13
      14-15FollowerRatio: Denormalized score for the age group 14-15
      :
      :
      70-71FollowerRatio: Denormalized score for the age group 70-71
      NumberOfVerifiedFollowers: Number of followers of friend a in
the Verified list
    }
```

Turning to FIG. 8, the computing system obtains the most likely age of as many users as possible, given a list of seeds whose follower age distributions are known.

In particular, at block 801, the computing system accesses the seed user database to obtain intermediate seed users, and remove all users who have less than M number of followers in the Verified list. In this way, users that are followed by too few people in the Verified list are removed as they do not provide meaningful information. In an example embodiment, M is 500. The remaining list is called the Seed list.

At block 802, for all users in the Seed list, the computing system finds all their distinct followers in the social data network, and removes users from the seed list who have less than a total of N followers in the social data network. In an example embodiment, N is 1000.

At block 803, for all users in this Seed list, the computing system identifies all their distinct followers on the social data network.

At block 804, for each given distinct follower, the computing system computes the given distinct follower's age distribution as an average of the follower age distributions of the users in the Seed list, which the given distinct follower follows.

At block 805, the computing systems denormalizes the results across a common baseline.

In an example aspect of implementing block 805, block 806 shows a series of operations to denormalize the results. For each age bin, the computing system computes the sum of the probabilities of all users in that age bin. The computing system then normalizes these sums across the different age groups, and obtains normalized “weights” for each age group. Then, for each given distinct friend, the computing system divides his/her age probabilities with the corresponding weights, and normalizes the scores to get new (denormalized) age probabilities for the given distinct friend.

At block 807, for each given distinct friend, the computing system computes his/her predicted age based on the age bin with the highest probability, and compute one or more confidence intervals around that age bin. For example, the computing system computes an 80% confidence interval around the predicated age or a 90% confidence interval around the predicated age, or both. For example, if the age bin 20-21 has the highest probability, then the one or more confidence intervals around that age bin are computed.

At block 808, the computing system stores these results in an age inference results database, each entry including an ID of a given distinct follower, a probability of being in a first age bin, a second probability of being in a second age bin, and so forth for other age bins, a value representing the age bin with the highest probability (called PointEstimate), one or more confidence intervals around the PointEstimate, and a number of seed friends of the given distinct follower.

In an example implementation, the results are stored in the following json format:

```
{
    ID: TwitterID of follower a
    12-13Ratio: Probability of a's being in the age group 12-13
    14-15Ratio: Probability of a's being in the age group 14-15
    :
    :
    70-71Ratio: Probability of a's being in the age group 70-71
    PointEstimate: Index of the age group which has the maximum
    probability
    80%_ConfidenceInterval: 80% Confidence interval around the
    point estimate
    90%_ConfidenceInterval: 90% Confidence interval around the
    point estimate
    NumberOfSeedFriends: Number of friends of follower a in the Seed
    list
}
```

In an example embodiment, the computations in blocks 803 to 808 occur in parallel for each given distinct follower. In other words, the computations for each distinct follower start at block 803 are independent from other distinct followers. In a non-limiting example embodiment, these computations are executed using Apache Spark, which is a cluster computing framework for massively parallel computer processing.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing systems described herein or any component or device accessible or connectable thereto. Examples of components or devices that are part of the computing systems described herein include the server system 101, the third party server(s) 102, and the computing devices 103. Any application or module herein described may be implemented using computer readable/executable instructions that may be stored or otherwise held by such computer readable media.

Examples embodiments and related aspects are below.

In an example embodiment, a computing system is provided comprising: a communication device configured to retrieve at least social network data comprising user accounts; one or more memory devices storing at least a relational database, a verified age database, a seed user database, and a results database; and one or more processors. The one or more processors are configured to at least: verify age data of the user accounts by submitting a name query via the communication device, and storing the user accounts with the verified age data in the verified age database; access the user accounts in the verified age database to compute seed user accounts and corresponding follower age distributions; store the seed user accounts and the corresponding follower age distributions in the seed user database; access the relational database to determine followers of the seed user accounts; and access and use the seed user accounts and the corresponding follower age distributions in the seed user database to determine an age attribute of the followers of the seed user accounts.

In an example aspect, each follower of the seed user accounts must follow at least a certain number of seed user accounts.

In another example aspect, verifying age data of a given user account comprises: obtaining an electronic text string representing the name of the given user account; accessing an information website and submitting a query on the information website using the electronic text string; and analyzing a resulting data entry on the information website to obtain a verified age of the given user account.

In another example aspect, the resulting data entry is a date of birth associated with the user account.

In another example aspect, verifying the age data of a given user account comprises: obtaining an electronic text string representing the name of the given user account; and conducting an electronic text string search of electronic text posts originating from or directed to the given user account, the electronic text string search including keywords that indicate the age data of the given user account.

In another example aspect, the verified age data comprises an ID of a given user account, a timestamp of a date that the verified age data is processed, and an age of the given user account as obtained.

In another example aspect, a given seed user account is a friend of multiple ones of the user accounts in the verified age database, and computing the given seed user account further comprises: representing a given age range as consecutive age bins that in total span the given age range; and identifying which fraction of the multiple ones of the user accounts in the verified age database that follow the given seed user account falls within each age bin to obtain a follower age distribution for the given seed user account.

In another example aspect, consecutive age bins together span a given age range, and wherein the seed user accounts and the corresponding follower age distributions comprise: an ID of a given distinct seed user account, a denormalized probability value for each age bin, and a number of user accounts in the verified age database that follow the given distinct seed user account.

In another example aspect, consecutive age bins together span a given age range, and wherein determining an age attribute of a given follower of the seed user accounts comprises: computing the given follower's age distribution as an average of follower age distributions of the seed user accounts, which the given follower follows; and determining the age attribute as an age bin with a highest probability.

In another example aspect, computations for determining age attributes of the followers of the seed user accounts are executed in parallel for each of the given followers using a cluster computer framework of the computing system.

It will also be appreciated that one or more computer readable mediums may collectively store the computer executable instructions that, when executed by a computing system, perform the computations described herein.

It will be appreciated that different features of the example embodiments of the system and methods, as described herein, may be combined with each other in different ways. In other words, different devices, modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A computing system for computing age for user accounts in a social data network, the computing system comprising:
a communication device configured to retrieve at least social network data comprising user accounts;
one or more memory devices storing at least a relational database, a verified age database, a seed user database, and a results database; and
one or more processors configured to at least:
verify age data of the user accounts by submitting a name query via the communication device, and storing the user accounts with the verified age data in the verified age database;
access the user accounts in the verified age database to compute seed user accounts and corresponding follower age distributions;
storing the seed user accounts and the corresponding follower age distributions in the seed user database;
accessing the relational database to determine followers of the seed user accounts; and
accessing and using the seed user accounts and the corresponding follower age distributions in the seed user database to determine an age attribute of the followers of the seed user accounts.

2. The computing system of claim 1 wherein each follower of the seed user accounts must follow at least a certain number of seed user accounts.

3. The computing system of claim 1 wherein verifying age data of a given user account comprises: obtaining an electronic text string representing the name of the given user account; accessing an information website and submitting a query on the information website using the electronic text string; and analyzing a resulting data entry on the information website to obtain a verified age of the given user account.

4. The computing system of claim 3 wherein the resulting data entry is a date of birth associated with the user account.

5. The computing system of claim 1 wherein verifying the age data of a given user account comprises: obtaining an electronic text string representing the name of the given user account; and conducting an electronic text string search of electronic text posts originating from or directed to the given user account, the electronic text string search including keywords that indicate the age data of the given user account.

6. The computing system of claim 1 wherein the verified age data comprises an ID of a given user account, a timestamp of a date that the verified age data is processed, and an age of the given user account as obtained.

7. The computing system of claim 1 wherein a given seed user account is a friend of multiple ones of the user accounts in the verified age database, and computing the given seed user account further comprises: representing a given age range as consecutive age bins that in total span the given age range; and identifying which fraction of the multiple ones of the user accounts in the verified age database that follow the given seed user account fall within each age bin to obtain a follower age distribution for the given seed user account.

8. The computing system of claim 1 wherein consecutive age bins together span a given age range, and wherein the seed user accounts and the corresponding follower age distributions comprise: an ID of a given distinct seed user account, a denormalized probability value for each age bin, and a number of user accounts in the verified age database that follow the given distinct seed user account.

9. The computing system of claim 1 wherein consecutive age bins together span a given age range, and wherein determining an age attribute of a given follower of the seed user accounts comprises: computing the given follower's age distribution as an average of follower age distributions of the seed user accounts, which the given follower follows; and determining the age attribute as an age bin with a highest probability.

10. The computing system of claim 9 wherein determining the age attribute of the given follower further comprises denormalizing and renormalizing probability values to a common baseline.

11. The computing system of claim 1 wherein computations for determining age attributes of the followers of the seed user accounts are executed in parallel for each of the given followers using a cluster computer framework of the computing system.

12. One or more non-transitory computer readable mediums for computing age for user accounts in a social data network, the one or more non-transitory computer readable mediums collectively comprising computer executable instructions that, when executed, cause a computing system to at least:
retrieve at least social network data comprising user accounts;
verify age data of the user accounts by initiating a name query, and store the user accounts with the verified age data in a verified age database;
access the user accounts in the verified age database to compute seed user accounts and corresponding follower age distributions;
store the seed user accounts and the corresponding follower age distributions in a seed user database;
access a relational database to determine followers of the seed user accounts; and
access and use the seed user accounts and the corresponding follower age distributions in the seed user database to determine an age attribute of the followers of the seed user accounts.

13. The one or more non-transitory computer readable mediums of claim 12 wherein each follower of the seed user accounts must follow at least a certain number of seed user accounts.

14. The one or more non-transitory computer readable mediums of claim 12 wherein the computer executable instructions for verifying age data of a given user account comprise: obtaining an electronic text string representing the name of the given user account; accessing an information website and submitting a query on the information website using the electronic text string; and analyzing a resulting data entry on the information website to obtain a verified age of the given user account.

15. The one or more non-transitory computer readable mediums of claim 14 wherein the resulting data entry is a date of birth associated with the user account.

16. The one or more non-transitory computer readable mediums of claim 12 wherein the computer executable instructions for verifying the age data of a given user account comprise: obtaining an electronic text string representing the name of the given user account; and conducting an electronic text string search of electronic text posts originating from or directed to the given user account, the electronic text string search including keywords that indicate the age data of the given user account.

17. The one or more non-transitory computer readable mediums of claim 12 wherein the verified age data comprises an ID of a given user account, a timestamp of a date that the verified age data is processed, and an age of the given user account as obtained.

18. The one or more non-transitory computer readable mediums of claim 12 wherein a given seed user account is a friend of multiple ones of the user accounts in the verified age database, and the computer executable instructions for computing the given seed user account further comprise: representing a given age range as consecutive age bins that in total span the given age range; and identifying which fraction of the multiple ones of the user accounts in the verified age database that follow the given seed user account fall within each age bin to obtain a follower age distribution for the given seed user account.

19. The one or more non-transitory computer readable mediums of claim 12 wherein consecutive age bins together span a given age range, and wherein the seed user accounts and the corresponding follower age distributions comprise: an ID of a given distinct seed user account, a denormalized probability value for each age bin, and a number of user accounts in the verified age database that follow the given distinct seed user account.

20. The one or more non-transitory computer readable mediums of claim 12 wherein consecutive age bins together span a given age range, and wherein the computer executable instructions for determining an age attribute of a given follower of the seed user accounts comprise: computing the given follower's age distribution as an average of follower age distributions of the seed user accounts, which the given follower follows; and determining the age attribute as an age bin with a highest probability.

21. The computing system of claim 20 wherein the computer executable instructions for determining the age attribute of the given follower further comprise denormalizing and renormalizing probability values to a common baseline.

22. The one or more non-transitory computer readable mediums of claim 12 wherein the computer executable instructions for determining age attributes of the followers of the seed user accounts are configured to be executed in parallel for each of the given followers using a cluster computer framework of the computing system.

23. A method performed by a computing system for computing age for user accounts in a social data network, the method comprising:
retrieving, using a communication device of the computing system, at least social network data comprising user accounts;
storing in one or more memory devices at least a relational database, a verified age database, a seed user database, and a results database; and
verifying, using one or more processors of the computing system, age data of the user accounts by submitting a name query via the communication device, and storing the user accounts with the verified age data in the verified age database;
accessing the user accounts in the verified age database to compute seed user accounts and corresponding follower age distributions;
storing the seed user accounts and the corresponding follower age distributions in the seed user database;
accessing the relational database to determine followers of the seed user accounts; and
accessing and using the seed user accounts and the corresponding follower age distributions in the seed user database to determine an age attribute of the followers of the seed user accounts.
